(19) United States
(12) Patent Application Publication
(10) Pub. No.: US 2007/0210595 A1
(43) Pub. Date: Sep. 13, 2007

(54) TIRE LIFTING BARS

(76) Inventors: Efrain Quiles, San Jose, CA (US); Francisco Duarte, San Jose, CA (US)

Correspondence Address: SCHNECK & SCHNECK, P.O. BOX 2-E, SAN JOSE, CA, 95109-0005, US

(21) Appl. No.: 11/683,793

(22) Filed: Mar. 8, 2007

Related U.S. Application Data
(60) Provisional application No. 60/767,183, filed on Mar. 8, 2006.

(51) Int. Cl. B65G 7/08

(52) U.S. Cl. 294/17

(57) ABSTRACT

A rim mounted tire lifting bar including a feature on a first end to allow lifting of rim up tires and a feature on the second end on lifting of rim down tires for tires mounted on a rim. A second bar includes an element on one end to engage the lip of one tire sidewall and allow tipping up of the tire when the tires not mounted on a rim. These may either be sold separately or sold together as a kit.

### CROSS-REFERENCE TO RELATED APPLICATION

This application claims priority from U.S. provisional application No. 60/767,183, filed Mar. 8, 2006.

### TECHNICAL FIELD

The present invention relates to tools and more specifically relates to tire lifting devices.

### BACKGROUND OF THE INVENTION

At facilities where large vehicles such as big rigs, tractors and other farm equipment, and industrial vehicles are maintained it is commonly necessary to perform work on vehicles tires. This often requires removing the wheel from vehicles and possibly subsequently removing the tire from the rim.

When such tires are placed upon the ground, manipulating or moving the tires can be awkward and difficult. In the course of a day's work, a tire repair technician that specializes in removing, repairing, and reinstalling large vehicles tires may have to lift numerous tires. These tires without a rim weigh between 115 to 150 pounds and with rims can weigh nearly 200 pounds. To lift such a tire when the tire is resting on the ground requires squatting or bending over. This process is difficult to do in an ergonomic manner. Improper lifting of the tire can cause back strain. A tire may have to be lifted five times or more per tire, per repair or replacement of a tire on a rim. It is an object to provide a tool that allows lifting of the large vehicle tires with undue back strain.

### SUMMARY

The above and other objects have been achieved with various embodiments of tire lifting tools and kits comprised of tire lifting tools. One embodiment is a tire lifting tool including an elongate bar having a first end and an second end. The first end has elements for allowing lifting of a tire facing rim up on a surface. The second end has elements for lifting a tire that is rim down on a surface. The rim of the elements may be one or more cylinders mounted at the end of the tool which may be fit into a large tire lug nut hole. The elements for lifting a rim down tire may include a section having a terminal raised lip and a spaced perpendicular crossbar that may serve as a counter pivot. The cylinder may be part of a upper and lower cylinder combination, wherein the lower cylinder has a larger diameter than the upper cylinder. At the base of the lower cylinder or a single cylinder may be an annular flange.

In an alternative embodiment, the tire lifting tool may be comprised of an elongate bar having a crossbar attached to one end of the elongate bar. A pair of tire engaging hooks may be mounted on the elongate bar. An element attached to the elongate bar is also included that presses against the sidewall of the tire when the hooks are placed inside the tire, again to act as a pivot point.

A further embodiment may be a kit of two tire lifting tools of the above embodiments. This kit would enable a shop owner to lift either a tire mounted on a rim or a rimless tire.

### BRIEF DESCRIPTION OF THE DRAWINGS

FIG. 1 is a top perspective view of rim mounted tire lifting bar.

FIG. 2 is a top perspective view of a first end of the bar shown in FIG. 1.

FIG. 3 is a top perspective view of the second end of the bar shown in FIG. 1.

FIG. 4 is a perspective view of the first end of the tool of FIG. 1 in use on a rim down wheel.

FIG. 5 is a top perspective detail of FIG. 4 showing the first end of the tool of FIG. 1.

FIG. 6 is a perspective view of showing a rim up wheel being tipped up using the second end of the tool of FIG. 1.

FIG. 7 is a perspective of a tilted up wheel engaged with the same end of the tool of FIG. 1 shown in FIG. 6.

FIG. 8 is a top perspective view of rimless tire lifting a bar.

FIG. 9 is a side profile view of the tool in FIG. 8.

FIG. 10 is a hook end detail of the tool of FIG. 8.

FIG. 11 is a view of the tool of FIG. 8 being used with a rimless tire.

FIG. 12 is a view of the tool of FIG. 8 as the rimless tire is lifted.

### DETAILED DESCRIPTION OF THE INVENTION

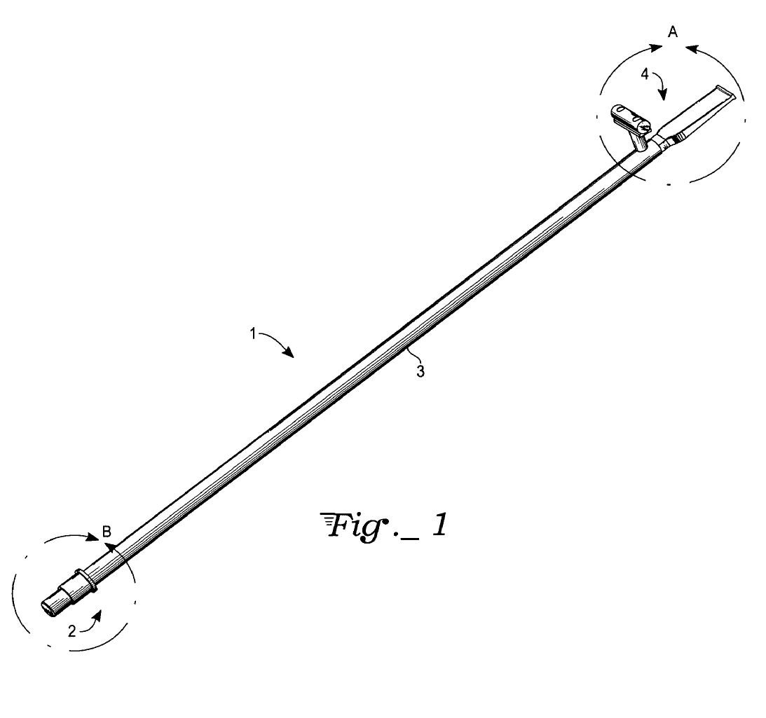

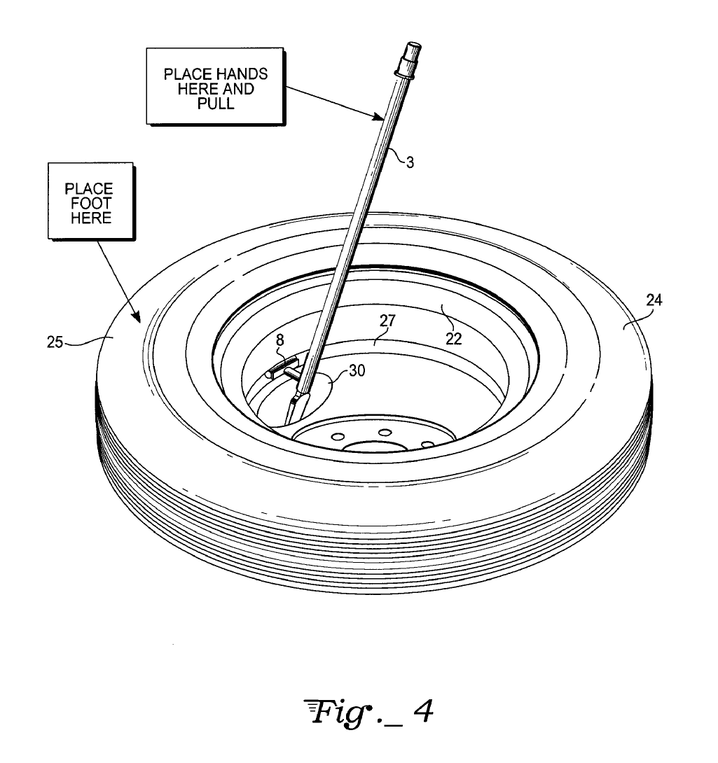

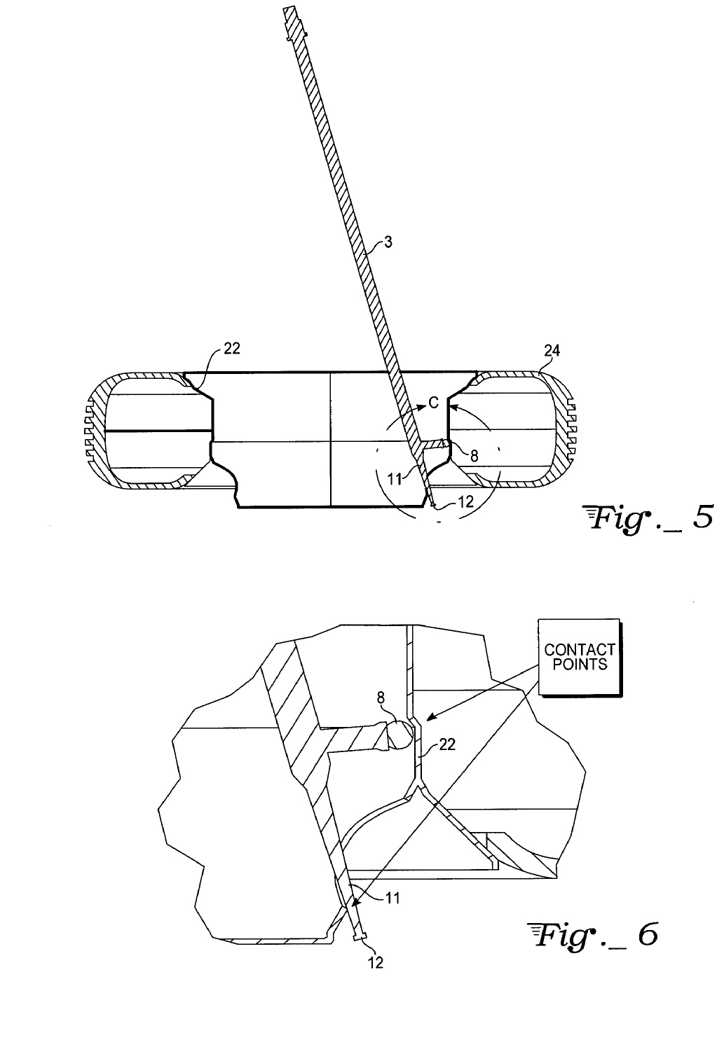

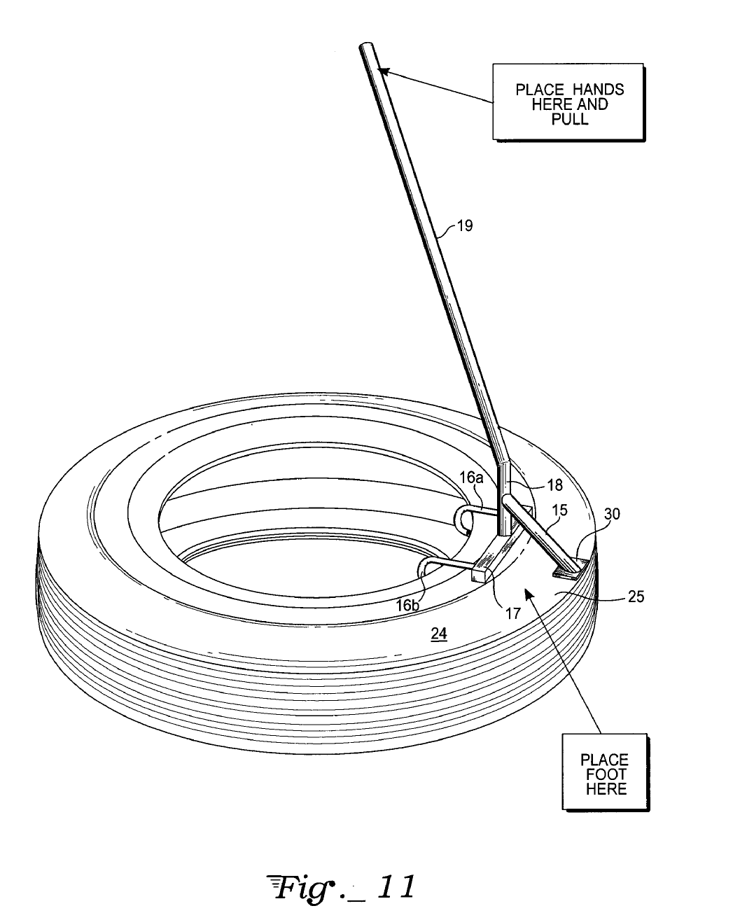

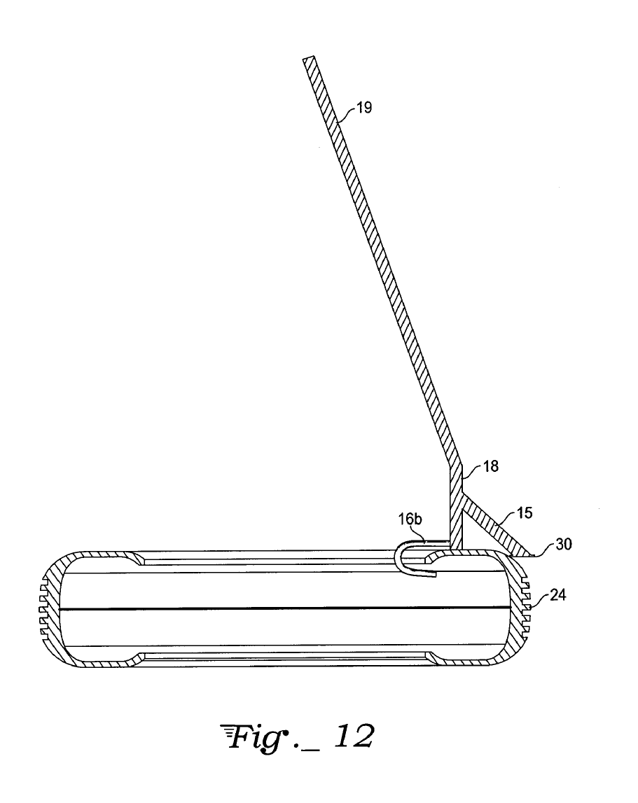

With reference to FIG. 1, in a first embodiment a rim mounted tire lifting bar 1 is shown. For the purposes of the present invention, the term “wheel” and “rim mounted tire” are synonymous, and refer to wholly or partially mounted tires mounted on rims, such as those pictured in FIGS. 4, 5, and 7. A rimless tire does not have an associated rim, like the rimless tires shown in FIGS. 11 and 12. This tool 1 includes an elongate bar 3 having a first end 2 and a second end 4. The first end, or rim up end, allows lifting of a tire having the face of the rim facing up. The second end 4, or rim down end, allows lifting of tires having the face of the rim face down. For the purposes of the present patent application the term “lifting” shall be understood to mean rotating of the tire from a position in which the sidewalls and/or rim of the tire are parallel to the ground to a position in which the sidewalls and/or rim of the tire are perpendicular to the ground.

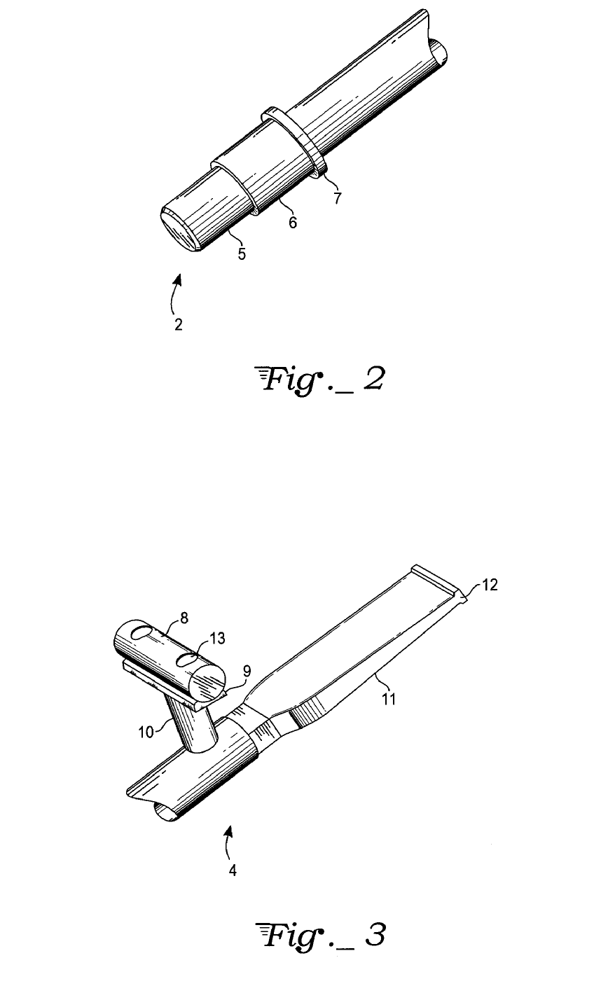

With reference to FIG. 2, the rim up lifting end 2 is illustrated. On this end one or more cylinders is positioned. The illustrated embodiment shows an upper cylinder 5 mounted centered over lower cylinder 6. At the base of lower cylinder 6 is an annular flange 7. When a tire is on the ground facing rim up, upper cylinder 5 may be inserted into a wheel rim lug nut hole of a first size, such as a hub pilot hole. The base of upper cylinder 5 is shown attached to a lower cylinder 6 such that the top of the lower cylinder 6 would be retained against the rim of the lug nut hole when cylinder 5 is inserted in the hole. The tire may then be tipped up using the bar as a lever. Lower cylinder 6 may be inserted into a slightly larger lug not hole, for example, Budd Stall holes. When a lower cylinder is inserted into such a hole the combined upper cylinder 5 and lower cylinder 6 are both inserted into the lug nut holes of the slightly larger size. Annular flange 7 at the base of cylinder 6 would then be retained against the hole rim.

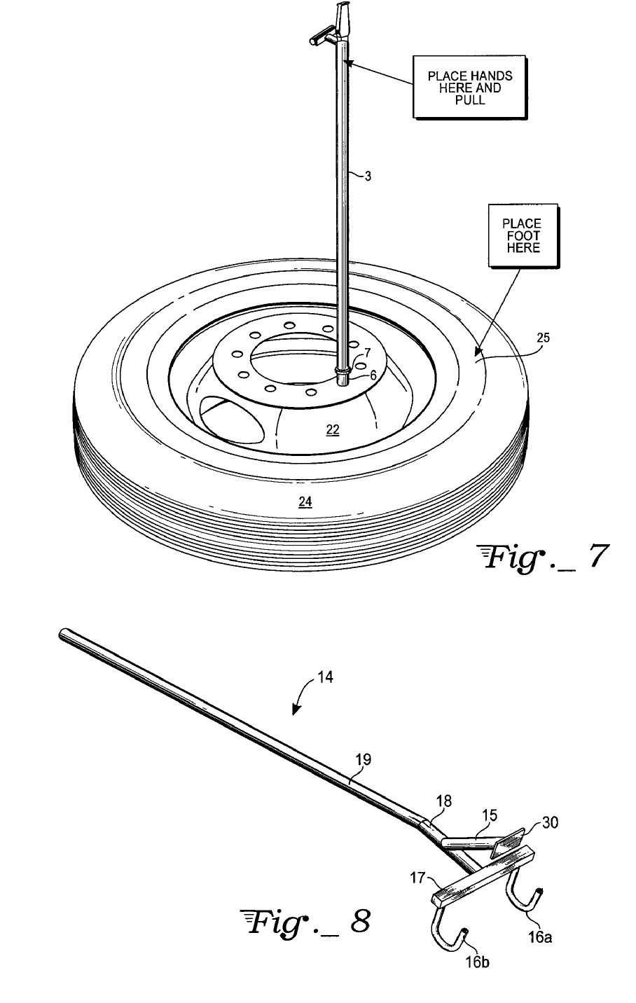

The use of this tool is shown in FIG. 7, the bar 3 is gripped by a user. The hands of the user grip the upper ends of the tool. The elongate bar of the tool is sufficiently long such that a user can comfortably grip the tool. The rim end is shown having the top cylinder (not shown) inserted into a lug nut hole on rim 22 which is mounted on wheel 24. The foot of the user rests against the sidewall of the tire (as at location 25) and by simply depressing the handle opposite end 2 and applying some pressure at location 25 to prevent the tire from sliding, the tire will rotate to an upright position. The use of this lever minimizes the force required for tipping of the tire and greatly reduces back strain.

With reference to FIG. 3, the second end of the bar 4 having means for lifting a rim up tire is shown. This end includes terminal lever arm 11 having a raised lip 12 at its distal end. Spaced from this distal end of lever arm 11 is a perpendicular positioned strut 10 topped by a laterally perpendicular crossbar 9. A resilient cylinder 8 is mounted on crossbar 9 by fasteners 13. The resilient cylinder may be a nylon cylinder or other suitable polymeric material such as rubber or a resilient plastic material. Fasteners 13 may be a bolt, screw, clip, pin or any other suitable fastener allowing resilient cylinder 8 to be secured onto crossbar 9. Crossbar 9 would then have a threaded hole or other suitable means for cooperatively working with a fastener 13 to allow resilient cylinder 8 to be secured onto the crossbar.

The use of this end of the tool to lift a tire is shown in FIGS. 4, 5, and 6. The raised lip 12 is placed in the valve stem hole 30 in the wheel rim 22 when the rim is facing the ground. When raised lip 12 on lever arm 11 is fit into the valve stem hole 30 resilient cylinder 8 may be rotated to press against an internal ridge 27 of the rim 22. This creates a pivot point to allow lifting of the tire 24 by lever action by pressing bar 3. This configuration prevents the tool from slipping on the rim while being lifted. As in the prior lifting method, the tool user would put one foot at location 25 on tire 24 during lifting to prevent the tire from slipping.

Terminal lever arm 11 and raised lip 12 can be adapted to a second function for use during removal of a tire from a rim. Specifically, lip 12 can be secured within the tire and lever arm 11 used as a wedge between the rim and tire band when removing the tire from the rim. For example, this tool may be used in conjunction with tire working tools such as those shown in U.S. Pat. No. 6,913,061 and U.S. Pat. Application Publication No. 2006/00196610 hereby incorporated by reference for all purposes herein.

This rim mounted tire lifting bar provides an ergonomic and convenient method for lifting either rim up or rim down tires.

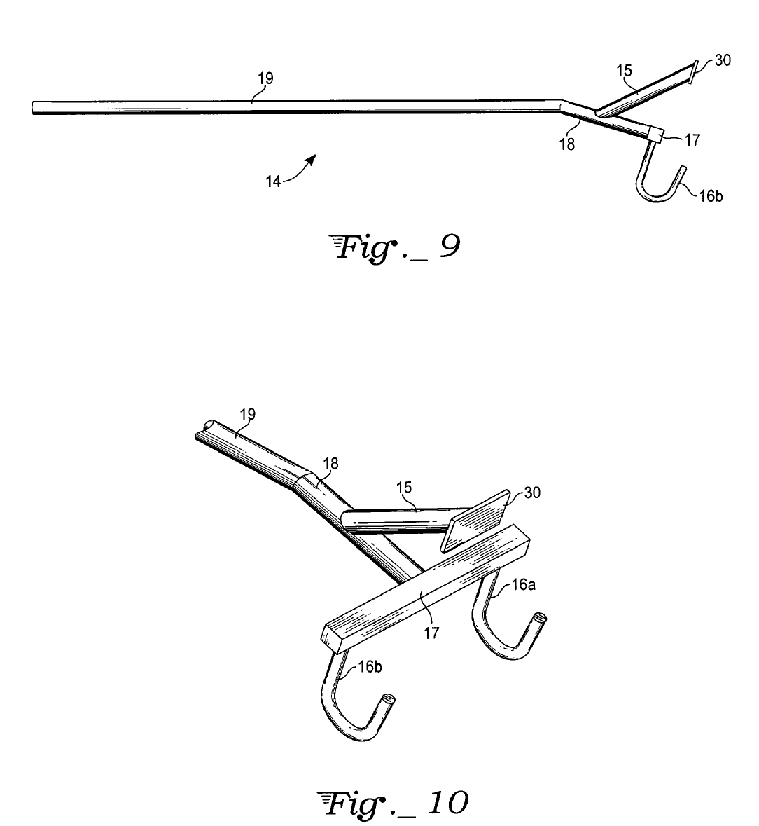

A second type of lifting bar is illustrated in FIGS. 8, 9, and 10. This includes a rimless tire lifting bar 14 and an elongate straight bar section 19 joined to an angled bar section 18. Mounted to a terminal end of angled bar section 18. Mounted to a terminal end of angled bar section 18 is a crossbar 17. Mounted on the two ends of crossbar 17 are tire hooks 16A, 16B. Mounted roughly midway on angled bar section 18 is diagonal strut 15 which has a terminal face pad 30. These elements are shown in use in FIGS. 11 and 12. In FIGS. 11 and 12 crossbar 17 rests against the sidewall of the tire 24 when hooks 16A, 16B are hooked over a lip of the tire sidewall. The face pad 30 rests against the other edge of the tire 24 sidewall. The bar 19 is angled away from the user. The user's foot also is placed at location 25 during use to prevent the tire from slipping. The user's hand then pulls back on the bar causing the tire to tip up. The hooks may then simply be disengaged from the sidewall and the tire rolled to any necessary location.

The rim mounted tire lifting bar may be made of a metal such as any appropriate low or high carbon steel. The rimless tire lifting bar 14 again may be made of a metal such as solid or hollow aluminum or steel members. The various elements may be manufactured by welding.

Each of the rim mounted tire lifting bar of FIG. 1 and rimless tire lifting bar of FIG. 8 may be either sold separately or sold together as a kit. As a kit, this provides a complete solution for tipping up either rim mounted tires or rimless tires. This kit aids technicians who work on tires and helps reduce work injury, protect rims from damage, increase repair and efficiency, and support the tire removal process. The tools may have a hard anodized surface treatment to ensure long tool life. The tools may be manufactured such that they are relatively light, durable, strong, and reliable.

What is claimed is:

1. A tire lifting tool comprising:
an elongate bar having a first end and a second end;
a means for lifting a rim up tire on said first end of said elongate bar; and
a means for lifting a rim down tire on said second end of said elongate bar.

2. The tool of claim 1, wherein said means for lifting a rim up tire includes a stop flange.

3. The tool of claim 1, wherein said means for lifting a rim down tire includes a resilient crossbar positioned such that during tire lifting the resilient crossbar contacts an outer rim location.

4. A tire lifting tool comprising:
an elongate bar having a first end and a second end;
at least one cylinder on said first end of said elongate bar, said at least one cylinder sized to fit into a large tire lug nut hole;
a terminal lever arm positioned at said second end of said elongate bar, said terminal lever arm having a raised lip at a distal end of said terminal lever arm;
a vertically substantially-perpendicular crossbar on said elongate bar proximate to a proximal end of said terminal lever arm; and
a laterally substantially-perpendicular crossbar attached to said vertically substantially-perpendicular crossbar.

5. The tool of claim 4, wherein said at least one cylinder includes an upper cylinder and a lower cylinder, said lower cylinder having a greater diameter than said upper cylinder, said upper and lower cylinders joined end to end.

6. The tool of claim 5, further comprising an annular flange at the base of said lower cylinder.

7. The tool of claim 4, wherein said terminal lever arm is wedge shaped.

8. The tool of claim 4, wherein said tool has a hard anodized surface.

9. The tool of claim 4, further including a resilient member mounted on said laterally substantially-perpendicular crossbar.

10. A tire lifting tool comprising:
an elongate bar;
a crossbar attached to one end of the elongate bar;
a pair of spaced tire engaging hooks mounted on said elongate cross bar; and
a diagonal strut attached to said elongate bar such that one end of said diagonal strut presses against a truck tire sidewall when said tire engaging hooks are placed inside a tire.

11. The tool of claim 10, wherein said elongate bar has an angled section onto which said crossbar and said diagonal strut are mounted.

12. The tool of claim 10, wherein said diagonal strut includes a terminal face plate.

13. A kit for lifting a rim mounted tire and a rimless tire comprising:
a first tool for lifting a rim mounted tire including:
a first elongate bar having a first end and a second end;
a means for lifting a rim up tire on said first end of said first elongate bar; and
a means for lifting a rim down tire on said second end of said first elongate bar;
a second tool for lifting a rimless tire comprising:
a second elongate bar;
a crossbar attached to one end of the second elongate bar;
a pair of spaced tire engaging hooks mounted on said crossbar; and
a strut means for pressing against a tire sidewall when said hooks are placed inside the rimless tire.
